(19) United States
(12) Patent Application Publication
(10) Pub. No.: US 2005/0219278 A1
(43) Pub. Date: Oct. 6, 2005

(54) Image formation with a flexible number of passes

(76) Inventor: Kevin R. Hudson, Camas, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/814,910

(22) Filed: Mar. 30, 2004

(51) Int. Cl. B41J 2/01

(52) U.S. Cl. 347/1

(57) ABSTRACT

A method of printing with a flexible number of passes is provided. Print data may be obtained. The print data may have a content defined by data elements corresponding to a pattern of dots of a colorant. It may be determined if at least one constraint on distribution of the print data exists so that forming the pattern in only one pass is precluded. If the at least one constraint exists, then subsets of the data elements, corresponding to interspersed sub-patterns of the pattern, may be distributed to a number of pass assignments. The number and the subsets may be determined by the content of the print data and the at least one constraint. The colorant may be delivered to overlapping regions of a print medium with passes performed according to the pass assignments to form the pattern.

### BACKGROUND

Printers may create a printed image on a print medium by firing ink droplets at the print medium from nozzles of a printhead to form a pattern of dots. The pattern of dots may be formed as a single swath or as a set of adjoining or overlapping swaths. Each swath may be created by ink delivery during one or more passes of the printhead across the print medium.

Printing speed, and thus throughput of print jobs, generally may be increased by printing each swath with a lower number of passes of the printhead. However, image quality may be degraded if the printhead exceeds its capacity to deliver ink efficiently by dispensing too many ink droplets per pass and/or exceeds the capacity of the print medium to absorb ink. Printers thus may be configured to form each swath during a fixed number of printhead passes. This fixed number may be selected, for example, to provide sufficient image quality even for “worst case” print data defining a high or maximum density of ink dots in a swath. In particular, a set of predefined masks may be used to distribute predefined subsets of the print data to a fixed number of pass assignments. These pass assignments may instruct delivery of ink droplets during a corresponding fixed number of printhead passes.

### BRIEF DESCRIPTION OF THE DRAWINGS

FIG. 1 is a view of a system for forming images by printing with an adjustable number of passes, in accordance with the present teachings.

FIG. 2 is a schematic view of the system of FIG. 1, in accordance with the present teachings.

FIG. 3 is a view of a flowchart illustrating a method of forming images by printing with an adjustable number of passes, in accordance with the present teachings.

### DETAILED DESCRIPTION

The present teachings provide systems, including apparatus and methods, for forming images, such as by printing, with an adjustable number of passes. The systems may distribute image data to pass assignments according to the content of the image data, for example, based on the arrangement, number, and/or density of data elements in the image data. The systems also may distribute the image data according to one or more constraints on distribution of the image data (and thus constraints on colorant delivery). This distribution may be performed with an algorithm and without predefined masks. The algorithm may repeatedly select different (nonoverlapping) subsets of the image data, in accordance with the one or more constraints, until the image data has been at least substantially or completely distributed to pass assignments. Accordingly, the number of pass assignments (and thus corresponding passes) may be based on the one or more constraints and on the content of the image data. Therefore, the number of pass assignments (and passes) selected may be determined flexibly by the image data and the constraints, so that the number of passes is minimized, and throughput maximized, without substantial degradation in the image quality.

The image forming systems may include apparatus configured to place visible image elements (such as dots) on a medium. The visible image elements may be formed with one or more colorants, such as inks, dyes, and/or other fluid or solid coloring agents. Colorants may impart any color (or colors) and/or color change(s), including black and/or white, to areas of a medium. Alternatively, or in addition, the visible image elements may be formed with one or more types of lights (such as light of different wavelengths), for example, by light projection or colorant excitation, among others. Accordingly, the image forming systems may include a printing apparatus or printer (such as an inkjet printer, a laser printer, a plotter, or the like), a projector, a television, and/or a display, among others.

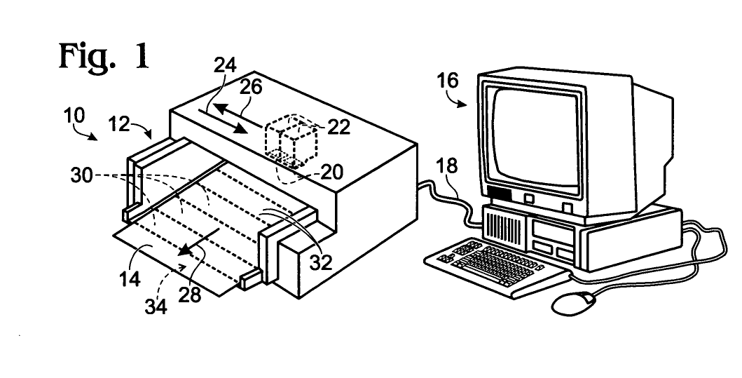

FIG. 1 shows an example of a system 10 for forming image by printing with a flexible number of passes. System 10 may include an image forming apparatus, such as a printer 12, configured to form images on (and/or in) medium 14. The medium may be a print medium, such as a sheet medium (for example, paper, cardboard, fabric, plastic, metal, glass, and/or the like). System 10 also may include a computing device 16 in communication, shown at 18, with the printer. The computing device may be configured to send image data in any suitable form to the image forming apparatus.

The image forming apparatus may include one or more image forming structures or devices, such as one or more printheads 20. Each printhead may be any device from which a colorant(s) is dispensed to a print medium. In the present illustration, printheads 20 are included in colorant cartridges 22 serving as colorant reservoirs. In other embodiments, colorant reservoirs may be disposed in a spaced relation to their printheads, that is, off-axis. In some examples, the image forming apparatus may include two or more substantially redundant printheads configured to dispense similar/identical colorants to overlapping or substantially identical regions of a print medium.

The printhead(s) may be stationary or may move relative to the print medium. In the present illustration, the printheads are configured to reciprocate by alternately traveling first in one direction 24, and then in the opposing direction 26, along an x-axis defined by the printer. Each printhead may perform passes during travel in each of the opposing directions (bi-directional printing) and/or during travel in only one of the directions (uni-directional printing). Accordingly, the term “pass,” as used herein, refers to one transit or passage of one image forming device across a region adjacent a medium, generally over the medium, during which the image forming device forms image elements on, in, and/or adjacent the medium, for example, by dispensing a colorant from the device during the passage. The transit may be performed by movement of the image forming device relative to the medium and/or movement of the medium relative to the image forming device. With redundant image forming devices, each image forming device can perform (or not perform) a distinct pass as it travels adjacent a region of the medium. For example, two redundant image forming devices traveling in tandem can perform a total of zero, one, or two passes as they travel once over a region of the medium.

The printer may be configured to move the print medium along a y-axis 28, so that the printheads (whether movable along the x-axis or stationary) can access different segments of the print medium to form swaths 30 of printed output. Alternatively, or in addition, the printer may be configured to move printheads along the y-axis as the print medium remains stationary to form the swaths. Each output swath 30 may be a segment accessed by travel of a printhead(s) across a region adjacent the print medium. The swath may extend across any suitable region of the print medium. For example, the swath may extend at least substantially (or completely) across the print medium, that is, to positions adjacent opposing edges of the print medium, or may extend across any suitable portion thereof. The output swaths may be adjoining, but substantially nonoverlapping, as shown here. Alternatively, the output swaths may be overlapping, for example, produced by partially overlapping passes of the printhead(s). Overlapping passes, as used herein, access overlapping regions 32 of a medium. The overlapping regions may be partially overlapping or at least substantially coextensive. Accordingly, overlapping passes may be completely overlapping or partially overlapping. However, colorant may be delivered to different areas within the overlapping regions by each of the overlapping passes, so that the overlapping passes form interspersed sub-patterns of dots in the overlapping regions. For a set of overlapping passes, as used herein, each pass of the set overlaps every other pass of the set.

One or more of the swaths may correspond to an image 34 defined by print data and printed by the image forming system. The image may be any suitable portion or all of a computer generated image (text, graphics, art, etc.), a photograph, and/or a digitized (or scanned) image (such as a picture, a drawing, a handwritten or printed document, etc.), among others. In some examples, the image is formed with a single colorant or with two or more colorants. In some examples, the image may be a single-colorant portion of a multi-colorant image.

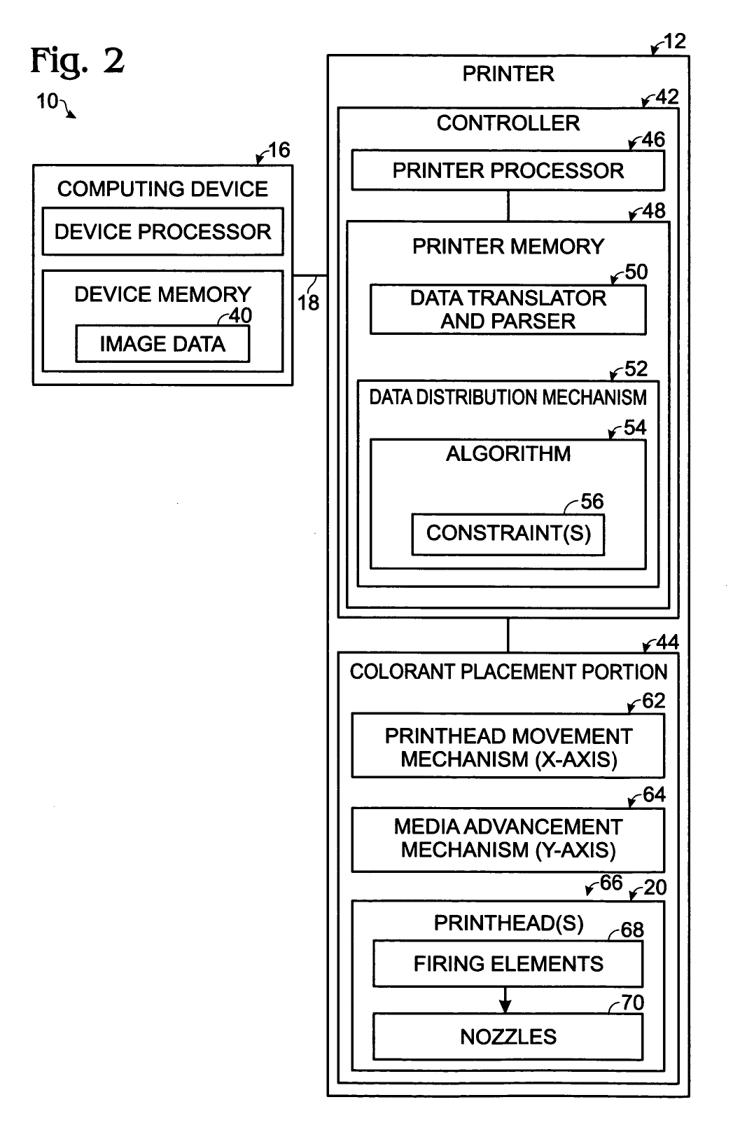

FIG. 2 shows a schematic view of exemplary system 10. Computing device 16 may be configured to send image (or print) data 40 defining an image to printer 12. Alternatively, or in addition, the computing device may be configured to parse data into image data sets corresponding to individual output swaths, convert the data to a different form, and/or distribute the image data to a flexible number of pass assignments based on the content of the image data, among others. However, in the present illustration, printer 12 is configured to perform these and other tasks that may be assigned alternatively, or in addition, to computing device 16.

Printer 12 may include a controller 42 and a colorant placement portion 44. Controller 42 may be configured to receive image data 40 from computing device 16 and process the image data into printing instructions for the colorant placement portion. As part of this processing, the controller may distribute image data to pass assignments based on the content of the image data and one or more constraints on distribution of the image data. Colorant placement portion 44 may be configured to dispense colorant positionally during passes performed according to pass assignments selected by the printer controller.

Controller 42 may include a printer processor 46 and printer memory 48. The printer processor may be configured to perform manipulation of image data received from the computing device and/or from the printer memory, including logic and/or arithmetic operations, among others. This processing of the image data may be performed based on processing instructions for the image data. Such processing instructions may be contained in printer memory 48 (such as hardware, firmware, and/or software, among others) and may include a data translator and parser 50, and a data distribution mechanism 52, among others.

Data translator and parser 50 may be any mechanism(s) for translating the image data into a different form(s) and/or parsing the image data into instructions for individual printed swaths (see FIG. 1). Data translation (or rendering) may include conversion of the image data into a more quantized form (such as conversion of a contone form of the image data into a halftone form), and/or conversion of image data to a different resolution, among others.

Data distribution mechanism 52 may be any mechanism for distributing the image data to a set of pass assignments. Pass assignments, as used herein, are portions of the image data designated to instruct colorant placement during corresponding passes of an image forming device (such as a printhead). The portions of the image data, when summed over the pass assignments, may at least substantially equal the image data. The data distribution mechanism may include an algorithm (or algorithms) 54 that performs the distribution of the image data based on the content of the image data and on one or more constraints 56 and without predefined masks.

A mask, as used herein, is a spatial pattern that is logically compared to image data to assign a subset of the image data to a particular pass assignment for implementation during a corresponding pass. For a fixed number of passes, masks may be designed as a complementary set, such that among a set of masks, all image data may be distributed to a fixed number of pass assignments and thus properly printed during a corresponding set of passes. For a flexible number of passes, the data distribution mechanism may create masks dynamically, that is, defined according to the content of the image data and one or more constraints, but not predefined. Application of these masks may set some data values to a null value (generally zero) to “mask” the corresponding data element so that this data element is not implemented in a particular pass (or passes).

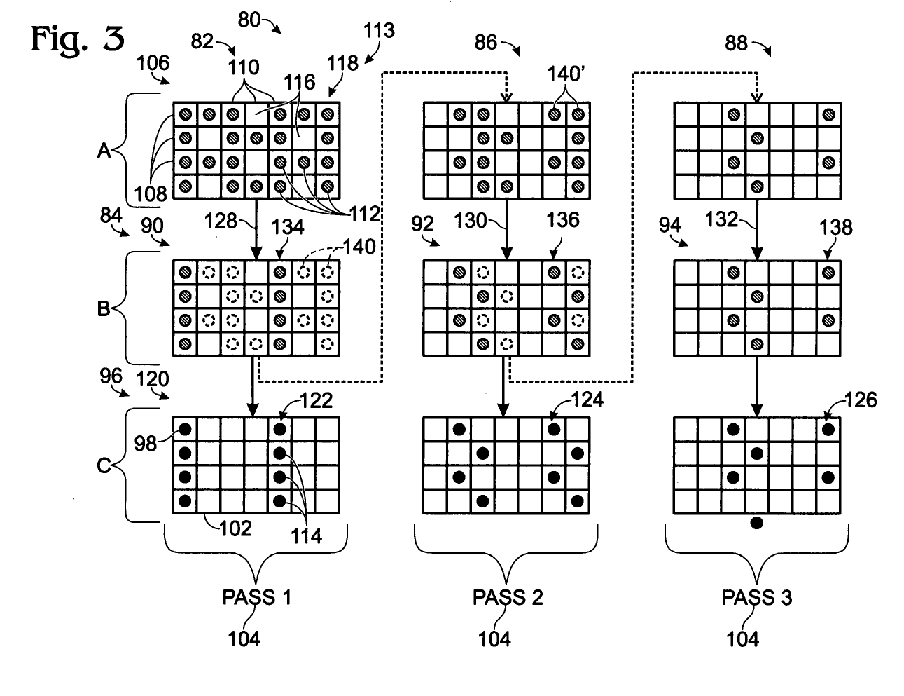

Algorithm 54 may be any recursive computational procedure configured to distribute the image data to pass assignments according to the constraint(s). Algorithm 54 may operate to distribute the image data to pass assignments without predefined masks. The algorithm may distribute the image data to pass assignments, by directly selecting different subsets of the image data without a mask. Alternatively, masks may be created based on an analysis of the image data performed by the algorithm, and then applied to the image data (or portions thereof. In some examples, the algorithm may be configured to at least substantially minimize the number of pass assignments (and thus passes) for producing output from print data in accordance with the constraint(s). The algorithm may be configured to repeatedly select different (nonoverlapping) subsets of the image data (that is, subsets with no implemented data elements in common), until all of the image data has been selected. In some examples, each selection by the algorithm may remove and/or nullify the selected subset from the image data, or a remainder thereof, to create a smaller, remaining portion of the image data. Selection may be repeated until the remaining portion has at least substantially none of the image data (for example, having only null elements/zeros). The size of each selected subset may be at least substantially maximized, in accordance with the at least one constraint, to minimize the number of pass assignments. Further aspects of algorithms and methods of pass assignment using algorithms are illustrated and described below in relation to FIG. 3.

Constraint 56 may be any limitation on how and/or how much print data is distributed to each pass assignment. Accordingly, the constraint may function as a rule by which the algorithm selects and maximizes the size of each print data subset selected during distribution of the print data. The constraint thus may be a limitation on the number and/or density of data elements that instruct dot formation within a pass assignment (generally, a matrix). This limitation may be defined per row (or set of rows), per column (or set of columns), per sub-matrix of any suitable size, and/or per entire matrix, among others. Alternatively, or in addition, the limitation may be defined relative to particular positions within the matrix. For example, a malfunctioning nozzle may define a row within the matrix in which data elements may not be distributed.

The constraint may correspond to a physical and/or mechanical constraint on colorant delivery. In some examples, the constraint may correspond to a limit on the firing rate and/or frequency of colorant droplets. The limit may be defined relative to a row(s) along which a nozzle travels, relative to a column(s) of nozzles, relative to a region(s) of the medium accessed by the nozzles, and/or relative to all the positions accessed by nozzles during an entire pass, among others. In some examples, the constraint may correspond to the capacity of media to absorb ink (a flux limitation). In some examples, the constraint may correspond to a particular nozzle(s) that should not be used to fire droplets (for example, because the particular nozzle(s) is malfunctioning).

The constraint(s) may be obtained in any suitable manner. The constraint may be preset (for example, by the manufacturer), may be input by a user, and/or may be input by a detector (such as a droplet/dot detector configured to identify malfunctioning nozzles), among others. In some examples, the constraint may be one or more constraints selected from a predefined set of constraints. The constraint may be selected by a user and/or may be selected automatically based on signals from the detector and/or based on user preferences for printing (such as preferences related to image quality, printing speed, type of image printed, etc.).

Colorant placement portion 44 may be configured to dispense colorant positionally to a medium. This portion may include a printhead movement mechanism 62, a media advancement mechanism 64, and a set of image forming structures 66, such as printheads 20 and/or nozzles. Printhead movement mechanism 62 may cause the printhead to reciprocate, as illustrated in FIG. 1. Alternatively, or in addition, the printhead movement mechanism may move the printhead in any other suitable direction(s), including two or three orthogonal directions, among others, or may be omitted from the printer. Media advancement mechanism 64 may move print media along an axis orthogonal to the axis defined by the printhead movement mechanism. In some embodiments, the printhead movement mechanism may perform the function of the media advancement mechanism by moving orthogonally. Alternatively, or in addition, the media advancement mechanism may move the media in orthogonal directions.

Image forming structures 66 may be any structures from which a particular colorant may be placed. Accordingly, the structures may be one or more printheads 20 configured to deliver the colorant. In some examples, a particular colorant may be delivered from two or more substantially redundant printheads configured to access overlapping and/or identical sections of a print medium. Printhead(s) may include firing elements 68, such as heater elements or piezoelectric elements. The firing elements may operate to expel colorant droplets from any array of image forming structures, such as nozzles 70, and onto a print medium. In some examples, one or more constraints may restrict use of particular nozzles, such as nozzles with a particular position and/or configuration within a printhead. The particular position may be, for example, nozzles disposed adjacent the periphery of a nozzle array and/or a subset of nozzles having a distinct orifice size, a nozzle associated with a distinct type of firing element, and/or the like.

FIG. 3 shows a flowchart schematically illustrating a method 80 of printing with an adjustable number of passes, in accordance with the present teachings. Method 80 may include an operation of obtaining print data 82. Method 80 also may include an operation, shown generally at 84, of distributing the print data 82. The print data may be distributed using the print data (or remaining, nondistributed portions thereof 86, 88, shown as a set of matrices in row A) to a plurality of pass assignments 90, 92, 94 (shown as a set of matrices in row B). In this example, the printhead motion is along the x-axis (left to right and/or right to left) and thus the print data is distributed according to this printhead motion. With other printhead movements (such as along the y-axis), the print data may be distributed accordingly. Method 80 further may include an operation, shown generally at 96, of delivering a colorant 98 to a print medium 102 during passes 104 performed according to pass assignments 90, 92, 94. (In the present illustration, print data/remaining portions 82, 86, 88, pass assignments 90-94, and print medium 102 each are shown to include an imaginary grid to facilitate comparison of data (hatched or dashed circles) and printed dots (solid circles.).

Print data 82 may be obtained in any suitable way from any suitable source. For example, the print data may be a halftone form of the print data created from a contone form of the print data. The halftone form may define the position of each colorant dot to be printed as a matrix 106 of rows 108 and columns 110. The print data may include implemented (valid) data elements 112, shown schematically as hatched circles, that correspond to colorant droplets to be delivered to print medium 102, and thus to printed dots 114 (see row C of FIG. 3). The row and column position of each data element may define the relative position in which a colorant dot is to be placed on a print medium. Thus, the print data may have a one-to-one correspondence between implemented data elements and colorant dots. Each implemented data element 108 may have a value or level (such as “1” in halftone data) that instructs placement of one colorant droplet or a plurality of colorant droplets. Other data elements 116 of the matrix, indicated as empty positions of the matrix, may be invalid or null elements (such as “0”) that are not implemented, that is, do not instruct formation of a colorant dot. These other data elements may operate as placeholders to define the row and column of implemented data elements 112.

The content 113 of the print data is defined by valid data elements 112. This content may relate to the total number, the overall or regional density, and/or the density in individual rows/columns or sets of rows/columns, among others, of these data elements. Alternatively, or in addition, this content may relate to an arrangement 118 of these data elements within matrix 106. Arrangement 118 may correspond to a pattern 120 of colorant dots 114 formed by superimposing interspersed sub-patterns 122, 124, 126 created by overlapping passes 104. Sub-patterns 122-126 are considered interspersed because they have one or more colorant dots 114 in one or more of the same row(s), and/or because as sets of dots they are disposed in and/or on overlapping regions of the print medium.

An algorithm may be used in method 80 to distribute valid data elements 112 according to one or more constraints. In the present illustration, the algorithm distributes the data according to a constraint limiting the density of valid data elements 112 per row 108 and corresponding to a limit on nozzle firing frequency during a pass. In the present illustration, the constraint is applied to each individual row in selecting pass assignment 90-94. In particular, this constraint limits each pass assignment to valid data elements 112 disposed in no more than one-fourth of the positions in each row. This limit may be imposed in any suitable fashion, such as an average occupancy per entire row, a limit on every contiguous set of four row positions in any reading frame, a limit on each set of four row positions defined in a particular reading frame, etc. Alternatively, or in addition, any other suitable constraint or constraints may be obtained and applied with the algorithm, as described further in relation to FIG. 2. Other exemplary constraints may be column constraints, that is, adjacency constraints within columns (along the y-axis) of the print data. Additional exemplary constraints may be row and column constraints, or “two-dimensional” firing constraints corresponding to constraints on the ability of a print medium to absorb ink (media ink flux capacity).

Distribution of print data 82 may be performed by repeated selection, shown at 128, 130, 132, of different subsets 134, 136, 138 of the print data. A first subset 134 may be selected from print data 82. The first subset may be selected according to the constraint so that the size of the first subset is at least substantially maximized without violation of the constraint. For example, in the present illustration, data elements are selected to create pass assignment 90 so that one-fourth of the matrix positions in every row, where possible, includes a valid data element 112. In some examples, there may be a firing position (valid data element) for every four consecutive firing positions in a row, that is, there should be at least three nonfiring positions (invalid data elements) preceding and following each firing position in a particular pass. With different arrangements/densities of data elements, a smaller or larger subset of the print data, relative to this illustration, may be selected initially from the print data in accordance with this constraint. In some examples, the first selection from the print data may select all of the print data for printing in a single pass. Nonselected data elements 140 (shown in dashed outline as invalid in row “B” of FIG. 3) may be removed actively from the pass assignment, for example, by copying the print data and then setting these data elements 140 to a null/invalid value so that they are “masked.” Alternatively, these nonselected data elements may be removed passively by selectively placing the selected subset 134 of the data elements in pass assignment 90 without the nonselected data elements 140.

A second round of selection may be performed on a remainder or remaining portion 86 of the print data, if any valid data elements 112 are present in this remainder. First remainder 86 may be created by removing selected subset 134 from print data 82, for example, by logically comparing pass assignment 90 with print data 82 and removing/invalidating (setting to null) every valid data element that is present in both. This operation may form a remaining portion of the print data corresponding to the nonselected data elements 140′ (top center of FIG. 3). The selection then may be repeated according to the constraint, so that the second pass assignment 92 has selected subset 136 configured so that valid data elements 112 are disposed at no more than one-fourth of the positions within each row. Nonselected subset (i.e., second remainder 88) may be deleted or omitted from pass assignment 92, as before (shown as hatched), and then used separately in a third round of selection, if necessary. The selection process can be repeated on a remainder produced by the preceding selection until at least substantially no valid data elements 112 remain.

It is believed that the disclosure set forth above encompasses multiple distinct embodiments of the invention. While each of these embodiments has been disclosed in specific form, the specific embodiments thereof as disclosed and illustrated herein are not to be considered in a limiting sense as numerous variations are possible. The subject matter of this disclosure thus includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

1. A method of printing with a flexible number of passes, comprising:
obtaining print data having a content defined by data elements corresponding to a pattern of dots of a colorant;
determining if at least one constraint on distribution of the print data exists so that forming the pattern in only one pass is precluded, and, if the at least one constraint exists, then:
(a) distributing subsets of the data elements, corresponding to interspersed sub-patterns of the pattern, to a number of pass assignments, the number and the subsets being determined by the content of the print data and the at least one constraint, and
(b) delivering the colorant to overlapping regions of a print medium with passes performed according to the pass assignments to form the pattern.

2. The method of claim 1, wherein obtaining print data includes receiving a contone form of the print data and converting the contone form to a halftone form of the print data, and wherein distributing is performed with the halftone form of the print data.

3. The method of claim 1, wherein delivering is performed with a printhead having a plurality of nozzles, and wherein determining includes obtaining a constraint corresponding to a limit on at least one of a rate of firing and a frequency of firing of at least a subset of the plurality of nozzles.

4. The method of claim 1, wherein delivering is performed with a printhead having a plurality of nozzles, and wherein determining includes obtaining identification of a subset of the nozzles that should not be used for delivering.

5. The method of claim 1, wherein distributing is performed sequentially to select and remove different subsets of the print data until at least substantially all of the data elements have been selected and removed.

6. The method of claim 1, wherein distributing is performed as a sequence of selections including a first selection and one or more subsequent selections, with each selection creating one of the subsets of the print data and a remaining portion of the data elements, and wherein each subsequent selection is performed on the remaining portion that is present when each subsequent selection is initiated.

7. The method of claim 6, wherein creating the remaining portion for at least one of the selections includes comparing the subset of the print data created by the at least one selection with a remaining portion of the print data present when the at least one selection was initiated.

8. The method of claim 1, wherein distributing is performed without a predefined mask.

9. The method of claim 1, wherein distributing is performed with an algorithm.

10. A method of printing with a flexible number of passes, comprising:
obtaining print data including data elements corresponding to a pattern of dots of a colorant included in a swath;
determining if at least one constraint on distribution of the print data exists so that forming the pattern in only one pass is precluded, and, if the at least one constraint exists, then:
(a) distributing subsets of the data elements with an algorithm to a minimum number of pass assignments permitted by the at least one constraint and the print data, the subsets corresponding to interspersed sub-patterns of the pattern, and
(b) delivering the colorant to overlapping regions of a print medium with a minimum number of passes corresponding to the minimum number of pass assignments to form the pattern.

11. The method of claim 10, wherein obtaining print data includes receiving a contone form of the print data and converting the contone form to a halftone form of the print data, and wherein distributing is performed with the halftone form of the print data.

12. The method of claim 10, wherein delivering is performed with a printhead having a plurality of nozzles, and wherein determining includes obtaining a constraint corresponding to a limit on at least one of a rate of firing and a frequency of firing of at least a subset of the plurality of nozzles.

13. The method of claim 10, wherein delivering is performed with a printhead having a plurality of nozzles, and wherein determining includes obtaining identification of a subset of the nozzles that should not be used for delivering.

14. The method of claim 10, wherein distributing is performed sequentially by the algorithm to select and nullify the subsets of the print data until at least substantially all of the data elements have been selected and nullified.

15. The method of claim 10, wherein distributing is performed by the algorithm as a sequence of selections including a first selection and one or more subsequent selections, with each selection creating one of the subsets of the print data and a remaining portion of the data elements, and wherein each subsequent selection is performed by the algorithm on the remaining portion that is present when each subsequent selection is initiated.

16. The method of claim 15, wherein creating the remaining portion for at least one of the selections includes comparing the subset created by the at least one selection with a remaining portion of the print data present when the at least one selection was initiated.

17. A method of printing with a flexible number of passes, comprising:
obtaining print data corresponding to a pattern of dots of a colorant disposed at a subset of positions within an array;
obtaining at least one constraint limiting distribution of the print data and defining a minimum number of passes for permitted delivery of the colorant to at least substantially all of the positions of the array;
distributing the print data to a plurality of pass assignments corresponding to interspersed sub-patterns of the pattern, the number of pass assignments being less than the minimum number; and
delivering the colorant to overlapping regions of a print medium according to the plurality of pass assignments with a corresponding plurality of passes to form the pattern.

18. The method of claim 17, wherein distributing is performed so that the number of pass assignments is configured to be a minimum permitted by the print data and the at least one constraint.

19. A program storage device readable by a processor, tangibly embodying a program of instructions executable by the processor to perform a method of printing with a flexible number of passes, the method comprising:
obtaining print data having a content defined by data elements corresponding to a pattern of dots of a colorant;
determining if at least one constraint on distribution of the print data exists so that forming the pattern in only one pass is precluded, and, if the at least one constraint exists, then:
(a) distributing subsets of the data elements, corresponding to interspersed sub-patterns of the pattern, to a number of pass assignments, the number and the subsets being determined by the content of the print data and the at least one constraint, and
(b) delivering the colorant to overlapping regions of a print medium with passes performed according to the pass assignments to form the pattern.

20. An apparatus for printing with a flexible number of passes, comprising:
a controller configured to obtain print data having a content defined by data elements corresponding to a pattern of dots of a colorant and also configured to determine if at least one constraint on distribution of the print data exists so that forming the pattern in only one pass is precluded, the controller including a data distribution mechanism configured, if the at least one constraint exists, to distribute subsets of the data elements, corresponding to interspersed sub-patterns of the pattern, to a number of pass assignments, the number and the subsets being determined by the content of the print data and the at least one constraint so that the pattern of dots will be formed on overlapping regions of a print medium with passes performed according to the pass assignments.

21. The apparatus of claim 20, wherein the data distribution mechanism includes an algorithm and operates independently of predefined masks.

22. A system for printing with a flexible number of passes, comprising:
a controller configured to obtain print data having a content defined by data elements corresponding to a pattern of dots of a colorant and also configured to determine if at least one constraint on distribution of the print data exists so that forming the pattern in only one pass is precluded, the controller including a data distribution mechanism configured, if the at least one constraint exists, to distribute subsets of the data elements, corresponding to interspersed sub-patterns of the pattern, to a number of pass assignments, the number and the subsets being determined by the content of the print data and the at least one constraint; and
one or more image forming devices configured to deliver the colorant to the overlapping regions of a print medium with a plurality of passes corresponding to the number of pass assignments to form the pattern of dots.

23. The system of claim 22, wherein the one or more image forming devices include one or more printheads.

24. A system for printing with a flexible number of passes, comprising:
means for obtaining print data having a content defined by data elements corresponding to a pattern of dots of a colorant;
means for determining if at least one constraint on distribution of the print data exists so that forming the pattern in only one pass is precluded;
means for distributing, if the at least one constraint exists, subsets of the data elements, corresponding to interspersed sub-patterns of the pattern, to a number of pass assignments, the number and the subsets being determined by the content of the print data and the at least one constraint; and
means for delivering the colorant to overlapping regions of a print medium with passes performed according to the pass assignments to form the pattern.

25. A method of printing with a flexible number of passes, comprising:
a step for obtaining print data having a content defined by data elements corresponding to a pattern of dots of a colorant;
a step for determining if at least one constraint on distribution of the print data exists so that forming the pattern in only one pass is precluded, and, if the at least one constraint exists, then:
(a) a step for distributing subsets of the data elements, corresponding to interspersed sub-patterns of the pattern, to a number of pass assignments, the number and the subsets being determined by the content of the print data and the at least one constraint, and
(b) a step for delivering the colorant to overlapping regions of a print medium with passes performed according to the pass assignments to form the pattern.
